(19) United States
(12) Patent Application Publication
(10) Pub. No.: US 2009/0129653 A1
(43) Pub. Date: May 21, 2009

(54) ENERGY BALANCING FOR WIRELESS DIAGNOSTIC IMAGING SYSTEM

(75) Inventors: John W. DeHority, Rochester, NY (US); Gordon Geisbuesch, Fairport, NY (US); Karin Topfer, Rochester, NY (US)

Correspondence Address: Carestream Health, Inc., 150 Verona Street, Rochester, NY, 14608, US

(73) Assignee: Carestream Health, Inc.

(21) Appl. No.: 11/940,494

(22) Filed: Nov. 15, 2007

(51) Int. Cl. H04B 17/00; G06K 9/36

(52) U.S. Cl. 382/132; 375/224

(57) ABSTRACT

A method for transferring data from a digital radiography receiver panel obtains, at the receiver panel, a full-sized set of image data that comprises a diagnostic image for a patient and at least one reference image for dark signal compensation. A wireless transmission channel between the receiver panel and a separate host processor is monitored to obtain a transmission performance measure. The obtained transmission performance measure is compared against a predetermined threshold value. The response to the comparison is either (a) processing at least some portion of the full-sized set of image data at the receiver panel to form a reduced-size set of image data, then wirelessly transmitting the reduced-size set of image data to the host processor; or (b) wirelessly transmitting the full-sized set of image data from the receiver panel to the host processor.

### FIELD OF THE INVENTION

This invention generally relates to digital diagnostic imaging apparatus that provides wireless transmission and more particularly relates to a method and apparatus for balancing on-board power consumption of a digital radiography receiver panel against processing and transmission efficiency for diagnostic image data.

### BACKGROUND OF THE INVENTION

Digital radiography (DR) increasingly is accepted as an alternative to film-based imaging technologies that rely on photosensitive film layers to capture radiation exposure and thus to produce and store an image of a patient's internal physical features. With digital radiography, the radiation image exposures electronically captured on radiation sensitive layers of a DR receiver panel are converted, pixel by pixel, to electronic image data which is then stored in memory circuitry for subsequent read-out and display on suitable electronic image display devices. One of the driving forces in the success of digital radiography is the ability to rapidly visualize and communicate stored images via data networks to one or more remote locations for analysis and diagnosis by radiologists without the delay caused by having to send physical films through the mail or via couriers to reach the remotely located radiologists.

A typical DR receiver panels includes a two-dimensional array of electronic detecting elements (“pixels”) organized in rows and columns. To read out electronic image data from the panel, rows of pixels usually are selected sequentially and the corresponding pixel on each column is connected to a charge amplifier. The outputs of the charge amplifiers from each column are then applied to analog-to-digital converters to generate digitized image data that then can be stored and suitably image processed as needed for subsequent display.

Early DR receiver panels obtained power and transmitted data to a host processor by means of a tethered cable arrangement. This type of configuration is acceptable under some imaging conditions; however, the need for cable routing and connection sometimes interferes with the ability to work efficiently in positioning the DR receiver panel with respect to the patient. In recognition of this difficulty, more recent designs have taken advantage of advances in short-range wireless data transmission, using technologies such as those exemplified in Bluetooth, IEEE 802.11G, OpenAir™, and other high-speed wireless transmission devices. Examples of DR panels using wireless transmission are given in commonly assigned U.S. Pat. No. 7,211,802 to Dhurjaty et al. and in U.S. Pat. No. 6,069,935 (Schick).

With regard to workability and system adaptability to different imaging conditions, high-speed wireless transmission clearly enjoys some advantages over conventional cabled transmission. However, there are drawbacks. One important consideration relates to the total amount of image data that must be obtained from the DR receiver panel for each imaging exam. The amount of data obtained in DR imaging can be sizable. For example, for a DR receiver panel of conventional size, 14×17 inches, with 2560×3072 pixels and 16-bit resolution, the size of a full resolution image is in the range of 16 Mbytes. Moreover, in a conventional DR imaging sequence, the following set of full-sized images is obtained for each exam:

(a) one full-resolution diagnostic image; and

(b) one or more reference images for dark signal compensation.

Typically, the reference images in item (b) include at least two or more “dark” or offset images that are used for dark signal compensation. Each reference image itself also is about 16 Mbytes for the exemplary DR receiver panel just described. Thus, for a single DR imaging exam, 48 Mbytes or more of image data may need to be transmitted. Under some conditions, four reference images are obtained, requiring transmission of 80 Mbytes.

As is well-known to those skilled in the wireless transmission arts, the speed of transmission over the same wireless channel under different conditions can vary in a manner highly dependent on the amount of electromagnetic noise in the transmission environment. This variable noise can be particularly troublesome and difficult to manage in a hospital environment that includes X-ray and other imaging equipment and various types of instruments and support systems equipment. Electrical noise can even reach levels that interfere with wireless transmission for extended periods, causing dropouts lasting up to 10 seconds or more. Thus, although wireless transmission can be very efficient in a relatively “quiet” environment, this type of low-noise environment cannot be guaranteed, particularly in a busy hospital atmosphere.

One method of compensating for high noise environments that might slow wireless transmission rates is to reduce the overall amount of data by applying some amount of image processing prior to transmission. This function can be performed by logic components that reside on the DR receiver panel itself. One or more of the reference images can be combined, for example, depending on the algorithm sequence that is used with these images. As another alternative, the diagnostic image can be combined with reference image data in order to generate the fully compensated image data that can be stored and used by the diagnostician. In a practical system, some combination of distributed image processing could be used, so that one portion of processing is done on the DR receiver panel and the balance of processing on a receiving host processor. By reducing the bulk amount of data that must be transmitted, distributed image processing can thus help to alleviate the problem of slow transmission rates in a noisy environment.

Whether the bulk, raw image data is sent with or without processing by the DR receiver panel, some type of battery power is needed on-board the DR receiver panel in a wireless arrangement. Simply collecting the image data itself requires battery power in wireless embodiments. The wireless transmission of the obtained data also requires battery power. Additionally, any amount of data processing by components on the DR receiver panel also requires battery power. The battery used for the DR receiver panel is typically a costly item, such as a rechargeable Lithium-ion cell, for example.

Recognizing the need for efficient management of power provided to a DR receiver panel, U.S. Pat. No. 6,924,486 entitled “Intraoral Sensor Having Power Conservation Features” to Schick et al. describes a battery power conservation system using state management to control the delivery of power to either the radiation-sensing components of a dental imaging sensor or the readout circuitry housed with the sensing components.

Simple power conservation, however, is only one factor of interest. In the medical environment, there can be value in enhancing the speed of image data transmission that overrides considerations of power usage and efficiency. In some medical situations, there is clearly a premium on obtaining image data as quickly as possible, regardless of battery power consumption.

Still other problems related to battery usage can be factors of interest for determining whether or not to process data locally at the DR receiver panel or to transmit the data for processing to a separate receiving host processor. Factors such as battery power level and heat generation can make it advantageous to transmit data rather than to expend the battery energy that would be needed in order to process the data on the DR receiver panel.

Although the problem of battery power management has been acknowledged, no suitable solutions for management of battery power particular to the DR imaging environment have been presented. More importantly, a solution is needed that allows some variability in battery power management for DR receiver panels based on transmission conditions and battery usage considerations, but also allows for needed image data delivery speed.

### SUMMARY OF THE INVENTION

It is an object of the present invention to advance the art of energy balancing for wireless diagnostic imaging methods and apparatus. With this object in mind, one embodiment of the present invention provides a method for transmitting image data from an imaging receiver panel, comprising steps of: a) obtaining, at the imaging receiver panel, a set of image data that comprises a diagnostic image for a patient; b) monitoring a wireless transmission channel between the imaging receiver panel and a host processor to obtain a transmission performance measure; c) comparing the obtained transmission performance measure against a predetermined threshold value; and d) responding to the comparison by either: (i) processing at least some portion of the set of image data at the imaging receiver panel to form a reduced-size set of image data, then wirelessly transmitting the reduced-size set of image data to the host processor; or (ii) without such processing, wirelessly transmitting the set of image data from the imaging receiver panel to the host processor. The set of image data may include a full-sized set of data for the diagnostic image, plus at least one reference image for dark signal compensation.

A second embodiment of the invention provides a method for transferring data from a digital radiography receiver panel, comprising steps of: a) obtaining, at the receiver panel, a set of image data that comprises a diagnostic image for a patient; b) monitoring a transmission channel between the receiver panel and a host processor by: (i) sub-sampling the diagnostic image to obtain a sub-sampled diagnostic image; (ii) transmitting the sub-sampled diagnostic image to the host processor; (iii) measuring transmission channel performance during transmission of the sub-sampled diagnostic image to obtain a transmission performance measure; c) comparing the obtained transmission performance measure against a predetermined threshold value; and d) responding to the comparison by either: (i) processing at least some portion of the set of image data at the receiver panel to form a reduced-size set of image data, then transmitting the reduced-size set of image data to the host processor; or (ii) without such processing, transmitting the set of image data from the receiver panel to the host processor.

A third embodiment of the invention provides a method for determining, for a digital diagnostic image, the number of additional dark signal reference images obtained from a digital radiography receiver panel, comprising steps of: a) obtaining a first reference image; b) subtracting the first reference image from the diagnostic image to obtain an offset-corrected image; c) segmenting the offset-corrected image into a plurality of blocks, wherein each block has multiple pixels in each direction; d) calculating statistical data from the plurality of blocks to identify one or more blocks according to their corresponding mean or median exposure values; and e) calculating, using statistical data obtained from the one or more identified blocks in step d), the number of additional reference images needed according to a predetermined threshold criteria for contrast or detail visibility or both.

A fourth embodiment of the invention provides a digital radiography receiver panel including: a sensor array for obtaining, at the receiver panel, a set of image data that comprises a diagnostic image for a patient; a wireless transmission module for transmitting data from the receiver panel over a wireless transmission channel to a location external to the receiver panel; and a control logic processor linked to the sensor array and the transmission module for processing the set of image data, controlling operation of the transmission module, comparing performance of the transmission channel to predetermined values, and selectively processing the set of image data by either: (i) processing at least some portion of the set of image data at the receiver panel to form a reduced-size set of image data, then wirelessly transmitting the reduced-size set of image data to the locations external to the receiver panel; or (ii) without such processing, transmitting the set of image data from the receiver panel to the locations external to the receiver panel.

A fifth embodiment of the invention provides a system for digital radiography, including: a host processor; a display for digital diagnostic images received from the host processor; a radiation source; and a digital radiography receiver panel comprising: (a) a sensor array for obtaining, at the receiver panel, a set of image data that comprises a diagnostic image for a patient resulting from exposure to the radiation source; (b) a wireless transmission module for transmitting data from the receiver panel over a wireless transmission channel to the host processor; (c) a control logic processor linked to the sensor array and the transmission module for processing the set of image data, controlling operation of the transmission module, comparing performance of the transmission channel to predetermined values, and selectively processing the set of image data by either: (i) processing at least some portion of the set of image data at the receiver panel to form a reduced-size set of image data, then wirelessly transmitting the reduced-size set of image data to the host processor; or (ii) without such processing, transmitting the set of image data from the receiver panel to the host processor.

A feature of the present invention is that it balances power consumption on the DR receiver panel and data transmission efficiency in an adaptive manner for diagnostic imaging systems.

An advantage of the present invention is that it allows on-panel configuration for weighting the decision-making process that determines how much image-processing is performed on the DR receiver panel based on measured performance of wireless image data transmission.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic block diagram that shows components of a digital imaging system having wireless transmission between a DR receiver panel and a separate host processor, according to one embodiment of the invention;

FIG. 2 is a logic flow diagram for image processing and wireless transmission from a DR receiver panel according to one embodiment;

FIG. 3 is a logic flow diagram showing the processing of comparison results;

FIG. 4 is logic flow diagram for determining the number of reference images obtained in one embodiment;

FIG. 5A is a block diagram showing a set of examples for balancing processing time and energy consumption;

FIG. 5B is a block diagram showing a set of alternate examples for balancing processing time and energy consumption; and

FIG. 5C is a block diagram showing yet another set of alternate examples for balancing processing time and energy consumption.

### DETAILED DESCRIPTION OF THE INVENTION

Those skilled in the art will understand and appreciate that elements not specifically shown or described may take various well-known forms.

The method and apparatus of the present invention provide logic and control processes for balancing two requirements for DR receiver panels: (i) displaying a fully corrected image to the operator, as quickly as possible; and (ii) extending battery life. As noted earlier in the background section, data transmission speed that impacts requirement (i) can be constrained by high noise levels in some environments. In response to high electromagnetic noise levels, some processing at the DR receiver panel can be useful, condensing the amount of image data for transmission.

Under some conditions, measures taken in order to satisfy either of requirements (i) and (ii) can be in conflict with each other. For example, maximizing wireless data transmission speed may require higher amounts of battery current, shortening battery life. Adjustments to the image data processing sequence, on the other hand, may help to conserve battery charge, but extend data transmission time. The method and apparatus of the present invention address the problem of battery charge vs. performance trade-offs and offer a control logic system that helps to manage the on-panel processing of diagnostic and dark signal compensation images for an x-ray or other diagnostic imaging apparatus. In doing this, the present invention helps to balance the requirements of image processing components with the requirements for wireless data transmission once this processing is completed.

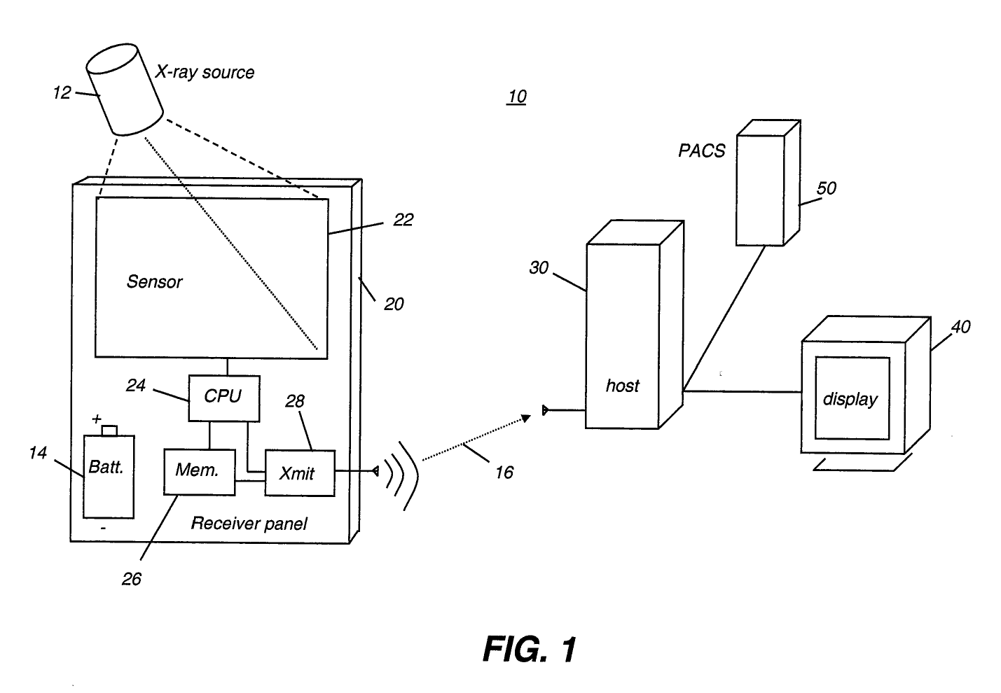

Referring to FIG. 1, there is shown a schematic block diagram of a diagnostic imaging system 10 according to an embodiment of the present invention. A DR receiver panel 20 obtains radiation that has passed through a patient's body (not illustrated) from a radiation source 12, such as an X-ray source. In DR receiver panel 20, a sensor array 22 having pixel elements converts the received radiation to charge data, which is then converted to digital data that is routed to a memory 26 by a control logic processor 24. In the embodiment shown, a wireless transmission module 28 is in communication with a separate host processor 30 and transmits signals over a wireless transmission channel 16. Typically, the transmitted signals include the data that has been obtained for a diagnostic image plus data for one or more reference images for dark signal compensation. Channel 16 also carries control signals for transmission and, typically, some additional amount of metadata in addition to the image data itself. Sensor array 22 and its supporting circuitry, as well as control logic processor 24, memory 26, and transmission module 28 all reside within DR receiver panel 20 and are powered by a battery 14.

Host processor 30, typically a computer workstation, but optionally a dedicated processor such as a microprocessor or other computer or logic processing component, provides whatever level of processing is needed for the image data it receives from DR receiver panel 20. Host processor 30 provides image data for a display 40 and typically also provides the processed image data to PACS (Picture Archiving and Communication Systems) or to one or more other appropriate networked storage or data management systems 50.

Control logic processor 24 contains the control and processing logic that is needed for executing the methods of the present invention. Control logic processor 24 can be a dedicated microprocessor, for example. One important function of control logic processor 24 is to perform, when applicable, some portion of the image processing that is needed for the diagnostic image obtained from sensor array 22. In embodiments of the present invention, this image processing function is shared by, and distributed between, control logic processor 24 and host processor 30. Thus, depending on sensed conditions and on weighted user settings, some part, or all, of the needed image processing may be performed on DR receiver panel 20 by control logic processor 24. With reference to the schematic diagram of FIG. 1, two components of DR receiver panel 20 are of particular importance for considerations of battery life and overall power consumption: transmission module 28 and control logic processor 24.

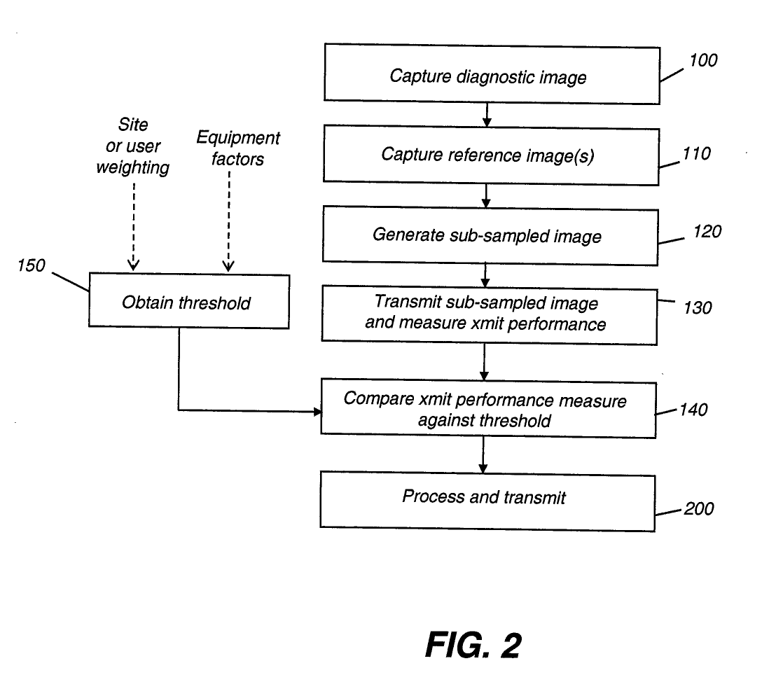

The logic flow diagram of FIG. 2 shows the overall steps that are used for initial processing of the image data and for determining the logic path that will be used for the image processing sequence with a particular image. In an image capture step 100, a diagnostic image of the patient is obtained by sensor array 22 and is temporarily stored in memory 26. Next, one or more reference images for dark signal compensation are obtained in a reference image capture step 110. Subsequently in this description outlines are provided of some of the logic that can be used to determine how many reference images are obtained.

At the conclusion of reference image capture step 110, then, a set of image data can be stored in memory 26. The image data in this initial set of image data includes full-sized images for both patient diagnosis and dark signal compensation. The steps that follow in FIG. 2 show the sequence for determining how much processing, if any, is applied to the full-sized image data in this first set of image data.

In one embodiment, this determination sequence begins with a sub-sampling step 120. A sub-sampled image is generated, providing a reduced-resolution version of the full-sized diagnostic image. The generation and transmission of a sub-sampled image have particular value with DR imaging apparatus, allowing the radiologist or technician to quickly obtain a lower-resolution “preview” of the full image. One use of this preview image would be to ascertain that diagnostic regions of interest are not clipped, for example.

Those skilled in the art will appreciate that some other test data could be substituted for the sub-sampled image for the purpose of testing and monitoring transmission channel 16. For example, a test pattern or a data file of suitable size for evaluating transmission efficiency can be used, making step 120 in FIG. 2 optional and transmitting only a test image instead of the sub-sampled image in step 130.

A transmission and measurement step 130 follows, in which DR receiver panel 20 transmits the sub-sampled image or test data to host processor 30. The transmission sequence is monitored by control logic processor 24, or by some dedicated processor (not shown) that is co-operating with control logic processor 24. Monitoring this sequence helps to characterize or profile the wireless transmission channel 16 between DR receiver panel 20 and its corresponding host processor 30. A performance measure of some type, indicating the relative performance of the wireless channel, is obtained from the monitoring logic. The performance measure could simply be a graded score that indicates the relative amount of time taken for the transmission. For example, if the transmission session for sending the sub-sampled image lasted from 50 to 200 msec, a score of 3 is assigned as the performance measure. For sessions lasting from 200 to 1,000 msec, a score of 5 is assigned. Sessions lasting longer than 1,000 msec (1 minute) receive a score of 9 as performance measure. As yet another option, the relative number of retries recorded for transmission of blocks of data could alternately be used as a performance measure. Of course, a more complex sequence for obtaining a transmission performance measure could be used. In any event, the performance measure is conditioned in some way by monitoring information that is obtained when transmitting a block of data, such as the sub-sampled image. In a comparison step 140 the performance measure that was obtained as a result of step 130 is compared to a threshold value. The result of this comparison is then used to determine the sequence that follows for processing the diagnostic and dark signal compensation image data and for subsequent transmission or the processed or unprocessed image data.

An obtain threshold step 150, which can be carried out asynchronously with respect to the capture and processing steps 100, 110, 120, and 130 shown in FIG. 2, provides a threshold value that can be used in the decision-making process of comparison step 140. In the context of the present invention, the term “threshold” is used broadly to describe some type of expected performance metric against which the measured performance obtained from transmission and monitoring step 130 can be compared. The threshold value for comparison can be generated from any of a number of variables, including preferential variables set by the user or site administrator and various equipment status conditions. In another embodiment, the threshold value is not algorithmically generated, but is simply assigned. For example, a threshold value can be assigned by a user of the system or by personnel who configure or administer the system.

Various equipment factors can also play a part in determining the threshold value for comparison in obtain threshold step 150. One equipment factor relates to heat generated during on-board processing. The processing of image data by control logic processor 24 can generate some amount of heat that can be sensed by a thermal sensor (not shown). Since excessive heat tends to degrade image quality, it may be advantageous to bypass on-board processing when heat levels rise above a certain level. A heat sensor (not shown) would provide information on temperature levels near control logic processor 24. Another equipment factor can relate to the amount of battery charge remaining. Generation of the threshold value in step 150 can be affected when the anticipated charge time is below a certain level, for example.

User or site administrator entries can also influence or set the threshold value that is obtained in step 150. For example, a site may prefer extended battery life over data transmission effectiveness and set a corresponding battery life preference parameter accordingly. On the other extreme, a site or an operator may want to optimize the speed with which the image is available at host 30 where possible, and ignore any impact of high transmission speed or processing operation speed on battery life. Various gradations between these two opposite poles are possible, based on weightings entered by the operator or computed by the system according to operator preferences or system requirements. In practice, a user may be allowed to override default settings or to adjust site settings for one or more exam sessions.

Still referring to FIG. 2, the result of the comparison then determines what happens in a process and transmit step 200. It can be appreciated that this sequence shown in FIG. 2 can be modified and adapted in any of a number of ways for determining how to process and transmit image data, dark signal compensation data, or both. In the simplest case, obtain threshold step 150 is optional and the performance measure that was obtained as a result of step 130 is used directly for subsequent steps. In the more general case, other factors, such as those described for operator preferences and equipment conditions influence the processing and transmission sequence.

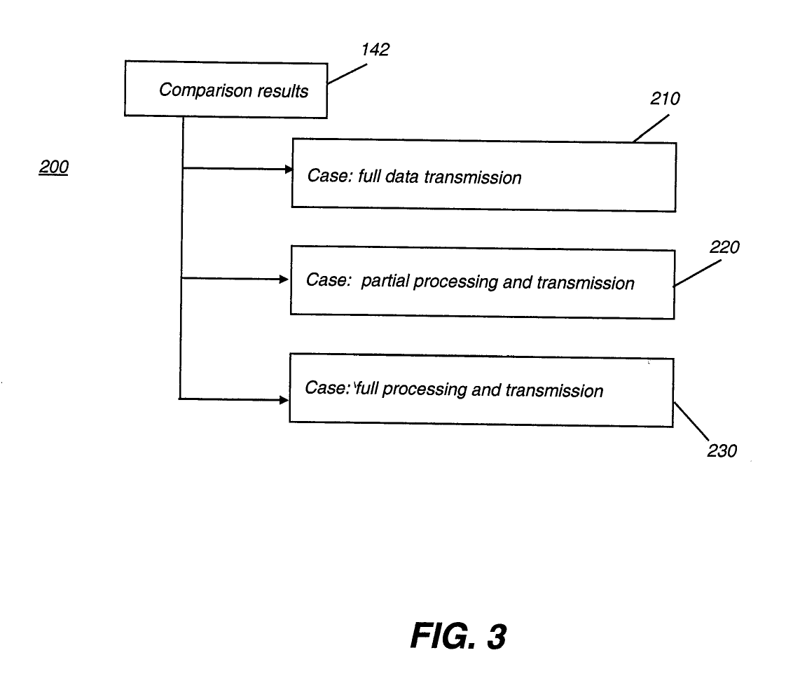

The logic flow diagram of FIG. 3 then shows how comparison results 142 from comparison step 140 (FIG. 2) influence process and transmit step 200. Based on comparison results 142, one of the cases shown in a full data transmission step 210 or in a processed data transmission step 220 or in a processed data transmission step 230 is executed. In full data transmission step 210, DR receiver panel 20 does no preliminary image processing, but merely transmits the image data or the dark signal compensation data or both, as obtained in steps 100 and 110 (FIG. 2). In processed data transmission step 220, DR receiver panel 20 does some, but not all, of the image processing that is needed, or condenses the total bulk of the image data obtained in some way. For example, two or more dark signal compensation images may be summed or otherwise combined, thereby reducing the amount of image data that must be wirelessly transmitted. Image compression could also be provided by control logic processor 24; however, only limited size reduction is possible using compression, since lossless image compression is generally required for diagnostic imaging applications. In processed data transmission step 230, DR receiver panel 20 performs all of the processing necessary for the image data, dark signal-compensation data, or both. The final image that is provided has the dark signal compensation applied to the image data and can be sent directly to a display apparatus or storage device without further processing by host processor 30 (FIG. 1).

### Monitoring and Controlling Processing

In addition to monitoring wireless transmission channel 16 between DR receiver panel 20 and host processor 30 for energy management, control logic processor 24 can also monitor and control processing performance at DR receiver panel 20. For example, the processor clock frequency can be changed according to user preference settings or to sensed conditions on DR receiver panel 20 itself or relative to transmission channel 16. Slower processor clock speeds reduce the rate of power consumption.

As one example, detection of a low battery condition for battery 14 can cause control logic processor 24 to slow the processing clock, reducing battery drain. Alternately, detection of poor transmission conditions on transmission channel 16 may have the reverse effect, causing an increase in processing clock speed so that image data can be more quickly processed at DR receiver panel 20 for transmission. The clock rate of control logic processor 24 affects the execution speed of any of the processes shown in FIG. 2.

### Periodic Monitoring Options

In an alternate embodiment, control logic processor 24 periodically monitors transmission channel 16 during idle periods rather than, or in addition to, monitoring the transmission of the sub-sampled image in step 130 (FIG. 2). For example, DR receiver panel 20 can transmit one or more periodically timed bursts of test data to host processor 30 and register the number of retries or reported errors. In this way, DR receiver panel 20 may be aware of long-term transmission channel conditions so that at least some amount of data that is useful for making the decision between image processing and transmission can be obtained prior to obtaining the diagnostic image.

### Adaptive Capture of Dark Signal Compensation Images

As described earlier, achieving a balance between data transmission efficiency and battery power is of particular interest because of the volume of reference image data that must be transmitted in addition to the diagnostic image data. A number of reference dark signal images are routinely obtained for dark signal compensation. For the purposes of the present invention, it can be useful to reduce the amount of reference dark signal image data either by reducing the number of reference dark signal images that are captured, or by combining the data for two or more of these reference images before transmission, or by performing the full processing procedure that conditions the diagnostic image data based on the reference image data.

In digital radiography, it is common practice to perform gain and offset corrections to reduce, to negligible levels, effects of noise resulting from different sensitivities of the individual pixels of the sensor (James A. Seibert, John M. Boone, Karen K. Lindfors “Flat-field correction technique for digital detectors”, Proc. SPIE Vol. 3336, 1998, p. 348-354). Moreover, it is common practice to average the image data from several dark signal captures before subtraction from the x-ray capture of the diagnostic image, to further reduce the noise in the generated dark map and therefore in the offset-corrected image. (Refer to Jean-Pierre Moy and B. Bosset, “How does real offset and gain correction affect the DQE in images from x-ray flat detectors?”, Proc. SPIE, 3659, 1999, pp. 90-97; Pieter G. Roos, Richard E. Colbeth, Ivan Mollov, Peter Munro, John Pavkovich, Edward J. Seppi, Edward G. Shapiro, Carlo A. Tognina, Gary F. Virshup, J. Micheal Yu, and George Zentai, Wolfgang Kaissl, Evangelos Matsinos, Jeroen Richters, and Heinrich Riem, “Multiple-gain-ranging readout method to extend the dynamic range of amorphous silicon flat-panel imagers”, Proc. of SPIE, 5368, 2004, pp. 139-149; and Endo, Tadao, “Radiological imaging apparatus and method”, U.S. Pat. No. 7,113,565 B2).

For a diagnostic imaging exam, Moy and Bosset recommend capturing 4-10 dark signal images for the best signal-to-noise performance. For a wireless, battery-operated DR receiver panel, this results in more power consumption and possibly more transmission time, depending on whether or not the dark averaging is performed on the DR receiver panel or on the remote host computer. Therefore it can be desirable to minimize the number of captured dark images without sacrificing the diagnosis of disease, the detection of medical implants, or increasing the dose to the patient.

X-ray procedures are performed for many different purposes and employ a number of different exposure techniques, varying factors such as tube voltage and filtration, for example. Tasks performed range from the diagnosis of fractured bones, to detection of cancer, to verification of tube placement in the Intensive Care Unit (ICU).

For each different task type, different exposures are used and the features of interest have different size and contrast characteristics. Likewise, the various types of images that are obtained may differ dramatically in dynamic range. For example, chest PA images have a dynamic range of up to 200:1, while hand images have a dynamic range that is typically below about 10:1. The feature of interest may be in the clear lung region for which the exposure received by the DR receiver panel is relatively high.

If only one dark image is captured, as opposed to averaging multiple captures, the additional noise is particularly visible in areas of low exposure and may affect the detection of low-contrast features. In addition, the visibility of fine detail at higher exposures may be impaired because of the additional frequency-independent noise floor. In order to calculate how many dark signal images should be obtained, it is useful to first characterize noise and its relationship to exposure and other variables.

The overall noise of a flat panel detector is the sum of electronic and quantum (Poisson) noise due to the statistical distribution profile of the impinging x-ray quanta. In terms of the noise power spectrum, N, electronic noise is independent of exposure, E, and spatial frequency, R. Quantum noise, on the other hand, is proportional to the exposure and decreases as a function of spatial frequency (Shahram Hejazi and David P. Trauernicht, “System considerations in CCD-based x-ray imaging for digital chest radiography and digital mammography”, Med. Phys. 24, 287 (1997)). For the noise power spectrum, the following equation holds:

$$N = \frac{( 1 + ɛ )}{q \cdot α} \cdot {S}^{2} \cdot {M ( R )}^{2} \cdot E + b \cdot {σ}^{2} \cdot A \qquad ( 1 )$$

where
α is the x-ray absorption;
ε is the detector excess noise;
q gives the x-ray fluence [quanta/mm²/mR];
S is the slope of linear detector code values vs. exposure in mR;
M gives the Modulation Transfer Function (MTF) of the detector;
R is the spatial frequency;
E is the exposure;
b is as defined below;
σ is the electronic noise, expressed as standard deviation of linear detector code values; and
A gives the pixel area in mm².

Assuming that the electronic noise between different dark signal images is uncorrelated, the factor b depends on the number of dark signal images, N_{d}, that were averaged to produce the offset map, using:

b=(1+1/N_{d}) (2).

Considering that many parameters in these equations do not depend on exposure or spatial frequency, Eq. 1 can be simplified to

N=C₁·M(R)²E+b·C₂ (3)

where C₁ and C₂ are constants.

Thus, quantum noise dominates at higher exposures E and the additional noise floor from capturing a smaller number of dark signal images may be negligible compared with the quantum noise. Moreover, the exposure threshold for quantum-limited operation depends on the maximum spatial frequency of interest, R_{T}. The selection of this parameter affects the visibility of fine detail.

After an initial calibration, it is possible to estimate the exposures in selected parts of the image based on digital code values that the detector recorded. The calibration can be performed as follows: Flat field images are taken at several exposure levels, and at each exposure level at least 1 dark signal image is taken and subtracted from the corresponding x-ray image. A dosimeter records the exposures in the imaging plane. If the detector response changes in proportion to exposure, a straight line can be fit, mapping detector code values to exposure. During the imaging sequence, the clinical x-ray image and one dark signal image are captured and the dark signal image is subtracted from the exposure to form an offset corrected image. For further increases in computation speed, the image may be sub-sampled before proceeding. The image is segmented into M×N square or rectangular blocks. Each block is dimensioned to have multiple pixels to a side, such as 128×128 pixels, for example. Statistical measures are then calculated for each block. These may include the mean, the median, the standard deviation, quartiles of code values or the maximum code value difference per block, for example.

It may be necessary to remove certain blocks from the analysis, for example areas of the image that are clipped to the highest and lowest possible digital codes values or masked by collimation blades. Next, the statistical measures can be sorted and the lowest block mean corresponding to the exposure ET can be found, for example.

As a next step, select the amount of permissible electronic noise as fraction, T, of quantum noise. As a general rule T will be below 1, so that the amount of quantum noise always exceeds the amount of electronic noise. The selection of T affects the lowest low-frequency contrast that can be detected in the image. Using Equations 2 and 3, the necessary number of dark signal images, N_{d}, can be calculated from:

$${C}_{1} \cdot {M ( {R}_{T} )}^{2} \cdot {E}_{T} \geq T \cdot ( 1 + \frac{1}{{N}_{d}} ) \cdot {C}_{2} \qquad ( 4 )$$

Another criterion that can be used is the minimum contrast-to-noise ratio, CNR, of the blocks:

$$C N R = \frac{{S}_{max} - {S}_{min}}{{σ}_{q + e}} \qquad ( 5 )$$

with Sₘᵢₙ and Sₘₐₓ as the minimum and maximum code value of the block and σ_{q+e} as the standard deviation of noise within the block. The latter can be estimated from Eqs 1-3, assuming for this simplified threshold calculation that the detector noise is frequency-independent:

$${σ}_{q + e} = \sqrt{( {C}_{1} \cdot \overline{E} + \frac{1}{1 + {N}_{d}} \cdot {C}_{2} ) \cdot \frac{1}{A}} \qquad ( 6 )$$

where A is the pixel area and Ē is the average exposure that the block received.

It is now required that, in order to reliably detect the target, the CNR exceed a threshold CNRₜ. Threshold CNR values above 3 are commonly used. Thus the number of required dark signal image captures N_{d} is calculated from the equation:

$$C N {R}_{t} < \frac{{S}_{max} - {S}_{min}}{\sqrt{( {C}_{1} \cdot \overline{E} + \frac{1}{1 + {N}_{d}} \cdot {C}_{2} ) \cdot \frac{1}{A}}} \qquad ( 7 )$$

All threshold values may depend on the type of exam conducted. Fine detail, that is, a higher value of the spatial frequency threshold R_{T}, may be needed in an extremity exam. In a chest exam, a low value of T may be needed to detect low-contrast nodules, but R_{T} can be lower than in the extremity exam because of the low spatial frequency content of the nodule. Low values of T and R_{T} may be sufficient if an image was taken to check tube placement. It is also possible to make all thresholds operator-selectable within certain limits via a graphical user interface on the host computer. These values can be downloaded to the panel via the wireless connection before acquiring the diagnostic image.

The constant C₁ varies as a function of the spectral composition of the x-ray beam, that is, the tube voltage and filtration. It can be measured under several common beam conditions and interpolated to cover intermediate beam conditions that were not measured.

Different standard x-ray spectra have been defined in IEC-62220-1 to approximate various exam types, as given in “Medical electrical equipment—characteristics of digital x-ray imaging devices—Part 1: determination of the detective quantum efficiency,” International Electrotechnical Commission (IEC), Geneva, Switzerland, 2003. These x-ray spectra are related to various beam conditions. The kVp (kilovolt potential) settings for RQA 3, 5, 7, and 9 correspond to approximately 50,70,90 and 120 kVp respectively for a tungsten source. For example, the RQA 9 beam is generally the best approximation for chest imaging.

The required number of dark signal images, N_{d}, calculated according to Eqs. 4 or 7 will, in most cases, yield a non-integer. Rounding rules can be established in order to obtain a suitable integer for the number of dark signal images. In practice, it has been found that the number of dark signal images obtained is most advantageous for simplifying calculation operations when it is a power of 2; that is 2⁰=1, 2¹=2, 2²=4, 2³=8, 2⁴=16, and so on.

In addition, image lag may be of some concern in cases where reference dark signal images are obtained subsequent to diagnostic image capture. Image lag is the image retention from frame to frame that can occur due to factors such as incomplete readout of the photodiode, afterglow of the scintillator, trapped charge in the a-Si photodiode, and other causes. The residual image decays over time in a predictable fashion and can be corrected as disclosed in U.S. Pat. No. 7,208,717 entitled “Method And Apparatus For Correcting Excess Signals In An Imaging System” to Partain et al. Image lag is proportional to exposure and its magnitude can be estimated by taking the difference of two dark frames captured at known time intervals after the exposure.

Lag correction is mainly of concern for higher exposures. Thus, it can be advantageous to find the highest block mean, Eₕ, from the analysis of the M×N square or rectangular blocks and then decide if lag correction, and thus obtaining at least 2 dark frames, is needed.

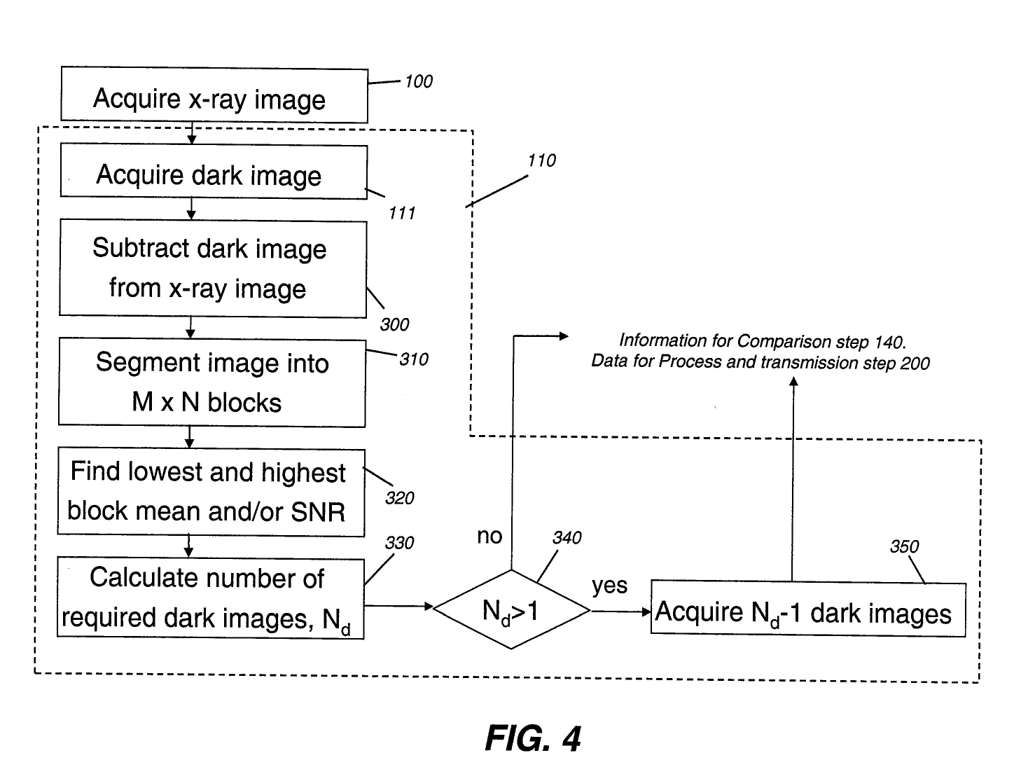

In one embodiment, a processing algorithm implemented on the panel or on the host computer, depending on the settings that control process and transmission step 200, would perform the sequence of operations shown in FIG. 4 to decide whether to obtain one or more dark images. Step 110, shown in a dashed outline in FIG. 4, corresponds to reference image capture step 110 in FIG. 2. The basic sequence for obtaining N_{d} dark signal images is as follows:
(1) As a preparatory step, characterize the DR receiver panel to obtain parameters needed in Eq. 1; repeat this process for different beam spectra;
(2) Store calibration constants C₁ and C₂ on the DR receiver panel;
(3) Store thresholds for detail M(R_{T}), and electronic vs quantum noise T, or CNR, CNTₜ, lag, Eₕ, and the maximum number of allowed dark signal images, N_{d,max} on the DR receiver panel or obtain this data from the operator, such as from operator input using a graphical user interface on the host; thresholds may vary by exam type;
(4) Capture the x-ray image in image capture step 100;
(5) Capture one reference dark signal image in reference image capture step 111; in the case of full data transmission, 210 (FIG. 3), this goes to transmission module 28 for transmission (otherwise, this is stored on the receiver panel);
(6) Optionally, sub-sample x-ray and dark signal images for increased calculation speed in sub-sampling step 120 (FIG. 2);
(7) Subtract the dark signal image from the x-ray image in a subtraction step 300;
(8) Segment the image into M×N blocks, each block dimensioned with multiple pixels per side, in a segmentation step 310;
(9) Calculate the mean or median of all of the blocks in a mean calculation step 320;
(10) Find the lowest and highest mean and median, excluding clipped areas or areas masked by collimation blades, for example;
(11) Calculate the needed number of reference dark signal images N_{d} in a calculation step 330, using processes and equations described earlier;
(12) If more than one reference dark signal image is needed, as determined in a decision step 340, capture additional dark signal images in a reference image capture step 350, up to the maximum number of dark signal images from step (3);

Following this sequence, image processing and transmission follows, using the comparison results for each case, as described with respect to FIG. 3.

### EXAMPLE

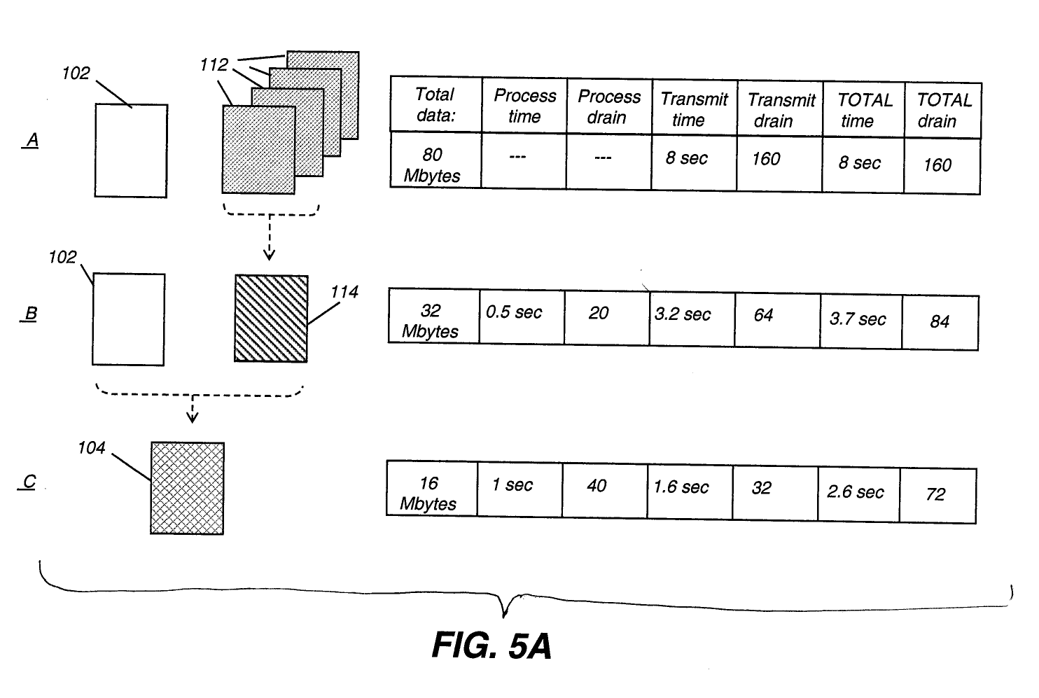

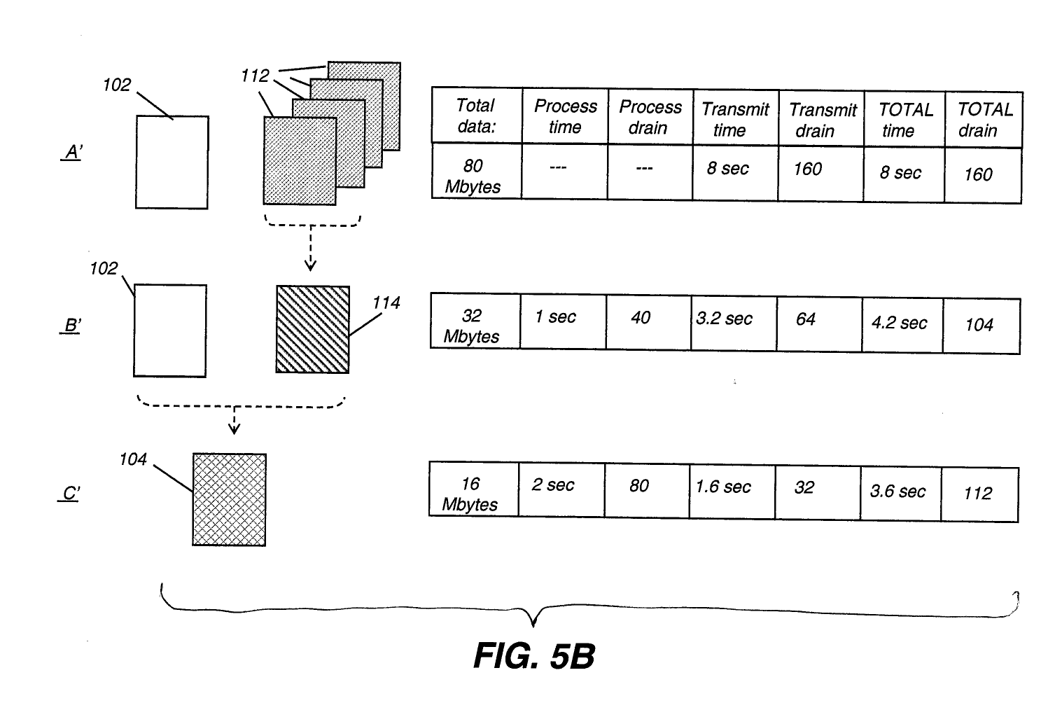

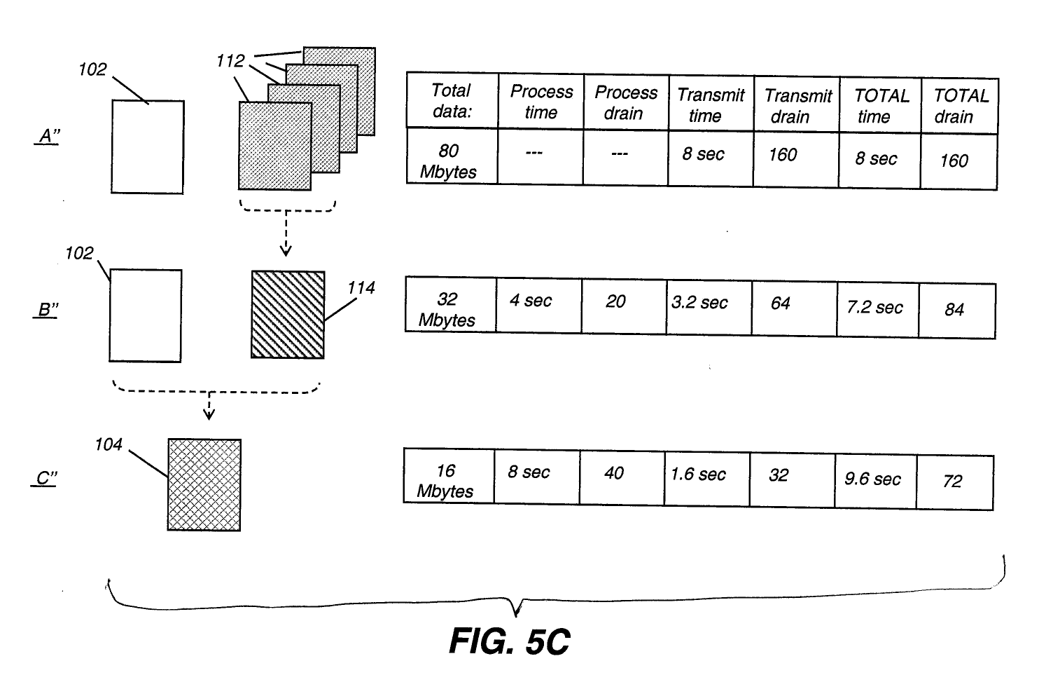

The block diagram of FIG. 5A gives an example that shows how the method of the present invention balances energy consumption against total processing and transmission times in one embodiment. For this set of examples, an average data transmission rate of about 1.6 seconds for 16 Mbytes has been calculated. Following the logic sequence given earlier for determining the number of reference dark signal images that are needed in this particular example, four reference dark signal images 112 were obtained for providing dark signal compensation to a diagnostic image 102. For an example A, no image processing is performed at DR receiver panel 20. The total transmission time is 1.6 seconds for each of the five 16 Mbyte images. The total energy consumption, shown for these examples in arbitrary units labeled “drain” is 160 units.

In example B of FIG. 5A, the four reference dark signal images 112 are combined in order to form a single combined reference dark signal image 114. For example, this combining operation may include functions such as addition, subtraction, division, or other more complex operation. This reduces the total amount of data and the total processing time, also reducing the energy requirements. The total drain value is reduced slightly to 84 units.

Example C of FIG. 5A shows the combination of combined reference dark signal image 114 with diagnostic image 102 to form a conditioned diagnostic image 104. The image data, now reduced to 16 Mbytes, transmits in 1.6 seconds. The total energy drain 72 is lowest in this embodiment. Clearly, given the transmission performance measure obtained for the example of FIG. 5A, there is an advantage in performing much of the image processing on DR receiver panel 20 and reducing the overall amount of data and energy consumption.

The alternate example of FIG. 5B shows the same image data that is processed and transmitted under different conditions. Here, transmission is the same, but processing time and energy consumption are increased. Example A′ shows the same time and energy consumption values. Example B′ shows an increase in time and drain, but is still smaller than Example A′. Example C′ shows increased drain over Example B′, with a very small time difference.

Examples A″, B″, and C″ given in FIG. 5C show a condition in which on-board processing takes considerably longer than in earlier examples, but at lower energy consumption than in Examples B′ and C′ of FIG. 5B. Example C″ in FIG. 5C shows the longest total time, but relatively low total battery drain.

It must be emphasized that the examples shown in FIGS. 5A, 5B, and 5C are illustrative of the general concept of the present invention. Factors not shown, such as operator preferences, may dictate the selection of one or more of these sequences. For example, the operator or site administrator may set a parameter that indicates a preference for transmission speed in one or more cases or, alternately, that indicates a preference for conserving battery power wherever possible. Processor clock timing may be reduced due to a low-battery condition. Other environmental factors such as heat, as noted earlier, can impact the decision-making process of an algorithm designed to implement the logic sequences shown in the example embodiments given earlier.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, while the preceding description has focused on the use and advantages of wireless transmission, the apparatus and method of the present invention can be used with a hard-wired data transmission channel. This method can be particularly useful, for example, where a data transmission channel uses a modem or other device whose transmission efficiency can be variable, based on the amount of data traffic in the transmission channel. Thus, what is provided is an apparatus and method for balancing on-board power consumption against processing and transmission efficiency for diagnostic image data.

### PARTS LIST

10. Diagnostic imaging system
12. Radiation source
14. Battery
16. Wireless transmission channel
20. DR receiver panel
22. Sensor array
24. Control logic processor
26. Memory
28. Wireless transmission module
30. Host processor
40. Display
50. Management system
100. Image capture step
102. Diagnostic image
104. Conditioned diagnostic image
110. Reference image capture step
111. Reference image capture step
112. Reference dark signal image
114. Combined reference dark signal image
120. Sub-sampling step
130. Transmission and monitoring step
140. Comparison step
142. Comparison results
150. Obtain threshold step
200. Process and transmit step
210. Full data transmission step
220. Processed data transmission step
230. Processed data transmission step
300. Subtraction step
310. Segmentation step
320. Mean calculation step
330. Calculation step
340. Decision step
350. Reference image capture step

1. A method for transferring data from a digital radiography receiver panel, comprising steps of:
a) obtaining, at the receiver panel, a set of image data that comprises a diagnostic image for a patient;
b) monitoring a wireless transmission channel between the receiver panel and a separate host processor to obtain a transmission performance measure; and
c) comparing the obtained transmission performance measure against a predetermined threshold value and responding to the comparison by either:
(i) processing at least some portion of the set of image data at the receiver panel to form a reduced-size set of image data, then wirelessly transmitting the reduced-size set of image data to the host processor; or
(ii) without such processing, transmitting the set of image data from the receiver panel to the host processor.

2. The method of claim 1, wherein the set of image data is full sized and the set further includes at least one reference image for dark signal compensation.

3. The method of claim 1 wherein the predetermined threshold value is weighted to decrease the amount of time between capture of the diagnostic image and image availability at the host processor.

4. The method of claim 1 wherein processing at least some portion of the image data comprises applying a compression algorithm.

5. The method of claim 2 wherein processing at least some portion of the image data comprises combining image data from two or more reference images for dark signal compensation.

6. The method of claim 2 wherein processing at least some portion of the image data comprises combining image data from the diagnostic image with image data from the at least one reference image.

7. The method of claim 1 wherein the predetermined threshold value is a factor of available battery power at the receiver panel.

8. The method of claim 1 wherein the predetermined threshold value is a factor of heat generation at the receiver panel.

9. The method of claim 1 wherein monitoring the transmission channel comprises transmitting a sub-sampled version of the diagnostic image data over the transmission channel from the receiver panel to the host processor.

10. The method of claim 1 wherein monitoring the transmission channel comprises transmitting test data over the transmission channel from the receiver panel to the host processor.

11. The method of claim 2 wherein the number of reference images that are obtained is an integer that is a power of two.

12. The method of claim 1 further comprising reducing the processing speed at the receiver panel according to a detected battery level.

13. The method of claim 2 wherein the number of reference images that are obtained is determined according to the difference between image code values for the diagnostic image and the at least one reference image.

14. The method of claim 2 wherein the number of reference images that are obtained is based on the imaged anatomy in the diagnostic image and on the diagnostic purpose of the examination.

15. The method of claim 2 wherein obtaining at least one reference image comprises:
a) obtaining a first reference image;
b) subtracting the first reference image from the diagnostic image to obtain an offset-corrected image;
c) segmenting the offset-corrected image into a plurality of blocks, wherein each block has multiple pixels in each direction;
d) calculating statistical data from the plurality of blocks to identify one or more blocks according to their corresponding mean or median exposure values; and
e) calculating, according to values in the statistical data calculated in step d), the number of additional reference images needed according to predetermined threshold criteria.

16. The method of claim 15 further comprising generating the predetermined threshold criteria according to contrast or detail visibility or both.

17. The method of claim 15 wherein the predetermined threshold criteria are user-defined.

18. A method for transferring data from a digital radiography receiver panel, comprising steps of:
a) obtaining, at the receiver panel, a set of image data that comprises a diagnostic image for a patient;
b) monitoring a transmission channel between the receiver panel and a host processor by:
(i) sub-sampling the diagnostic image to obtain a sub-sampled diagnostic image;
(ii) transmitting the sub-sampled diagnostic image to the host processor;
(iii) measuring transmission channel performance during transmission of the sub-sampled diagnostic image to obtain a transmission performance measure; and
c) comparing the obtained transmission performance measure against a predetermined threshold value and responding to the comparison by either:
(i) processing at least some portion of the set of image data at the receiver panel to form a reduced-size set of image data, then transmitting the reduced-size set of image data to the host processor; or
(ii) without such processing, transmitting the set of image data from the receiver panel to the host processor.

19. The method of claim 18, wherein the set of image data is full sized and the set further includes at least one reference image for dark signal compensation.

20. The method of claim 19 wherein processing at least some portion of the full-sized set of image data comprises averaging image data from two or more reference images.

21. A method for determining, for a digital diagnostic image, the number of additional dark signal reference images obtained from a digital radiography receiver panel, comprising steps of:
a) obtaining a first reference image;
b) subtracting the first reference image from the diagnostic image to obtain an offset-corrected image;
c) segmenting the offset-corrected image into a plurality of blocks, wherein each block has multiple pixels in each direction;
d) calculating statistical data from the plurality of blocks to identify one or more blocks according to their corresponding mean or median exposure values; and
e) calculating, using statistical data obtained from the one or more identified blocks in step d), the number of additional reference images needed according to a predetermined threshold criteria for contrast or detail visibility or both.

22. A digital radiography receiver panel, comprising:
a sensor array for obtaining, at the receiver panel, a set of image data that comprises a diagnostic image for a patient;
a wireless transmission module for transmitting data from the receiver panel over a wireless transmission channel to a location external to the receiver panel; and
a control logic processor linked to the sensor array and the transmission module for processing the set of image data, controlling operation of the transmission module, comparing performance of the transmission channel to predetermined values, and selectively processing the set of image data by either:
(i) processing at least some portion of the set of image data at the receiver panel to form a reduced-size set of image data, then wirelessly transmitting the reduced-size set of image data to the locations external to the receiver panel; or
(ii) without such processing, transmitting the set of image data from the receiver panel to the locations external to the receiver panel.

23. A system for digital radiography, comprising:
a host processor;
a display for digital diagnostic images received from the host processor;
a radiation source; and
a digital radiography receiver panel comprising:
(a) a sensor array for obtaining, at the receiver panel, a set of image data that comprises a diagnostic image for a patient resulting from exposure to the radiation source;
(b) a wireless transmission module for transmitting data from the receiver panel over a wireless transmission channel to the host processor; and
(c) a control logic processor linked to the sensor array and the transmission module for processing the set of image data, controlling operation of the transmission module, comparing performance of the transmission channel to predetermined values, and selectively processing the set of image data by either:
(i) processing at least some portion of the set of image data at the receiver panel to form a reduced-size set of image data, then wirelessly transmitting the reduced-size set of image data to the host processor; or
(ii) without such processing, transmitting the set of image data from the receiver panel to the host processor.
